(19) United States
(12) Patent Application Publication
(10) Pub. No.: US 2013/0249844 A1
(43) Pub. Date: Sep. 26, 2013

(54) SYSTEM AND METHOD FOR INPUT DEVICE LAYOUT

(71) Applicant: 1LINE INCORPORATED, Richmond Hill (CA)

(72) Inventors: Frank Chun Yat LI, Richmond Hill (CA); Khai Nhut Truong, Atlanta, GA (US); Richard Thomas Guy, Toronto (CA); Koji Yatani, Ikoma-gun (JP)

(73) Assignee: 1LINE INCORPORATED, Richmond Hill (CA)

(21) Appl. No.: 13/898,671

(22) Filed: May 21, 2013

Related U.S. Application Data
(63) Continuation of application No. PCT/CA2012/050716, filed on Oct. 11, 2012.
(60) Provisional application No. 61/547,398, filed on Oct. 14, 2011.

(51) Int. Cl. G06F 3/02

(52) U.S. Cl. CPC G06F 3/0216
USPC 345/173

(57) ABSTRACT

A system and method for input device layout is provided. The input device may be a soft or physical keyboard. The input device is laid out based on contact points provided by one or more users. A layout unit determines optimal size and location of inputs on the input device. A one line keyboard is also provided. A disambiguation utility is also provided. An adaptive input device is also provided. In a further aspect, a disambiguation utility is provided for disambiguating input provided on an input device. An input device comprising a combination of a soft input device and physical inputs is provided. A soft keyboard comprising one or more soft keys and one or more gesture based inputs is provided.

### CROSS REFERENCE

This application is a continuation of PCT patent application no. PCT/CA2012/050716, filed Oct. 11, 2012, which claims priority to U.S. provisional patent application No. 61/547,398 filed Oct. 14, 2011, both of which are incorporated herein by reference.

### FIELD OF THE INVENTION

The present invention relates generally to input devices. The present invention relates more specifically to determining a layout for such input devices.

### DESCRIPTION OF THE PRIOR ART

Touchscreen computing devices are becoming increasingly popular. Consumer oriented touchscreen devices include tablet computers, desktop computers, smart phones and portable music players, among others. Touchscreen devices are also used for commercial and industrial applications.

Touchscreens allow the input and output space of the device to be completely overlapped. This removes the need for physical input keys. To support typing on touchscreens without additional hardware, many touchscreen devices implement a software based input means that consumes a significant amount of the device's display space.

A common example of the foregoing is a soft QWERTY keyboard, such as is provided on many tablet computers. These soft keyboards often consume more than one third of the available display space. Additionally, the layout of current soft keyboards may not be ergonomic and may not reflect the points at which users' fingers would naturally contact the display.

These issues can diminish the overall user experience for these devices.

In one survey, for example, fifty (26 male, 24 female) tablet computer users (of an Apple™ iPad™) were asked to report their satisfaction with its soft keyboard. Although survey respondents reported very frequent usage of their tablet computer and liked their overall experience, they also indicated a desire to minimize the space occupied by the soft keyboard. Respondents rated the display size of the iPad with a median of 5 (1: very unsatisfied, 5: very satisfied); however, the rating significantly dropped to a median of 4 for the display size with the keyboard visible (Friedman, χ² (1)=21.2, p<0.001). One particular user's comment expressed satisfaction with keyboard size, but dissatisfaction with remaining screen size dedicated to output, which required the user to frequently scroll up and down to view content.

It is an object of the present invention to obviate or mitigate at least one of the above disadvantages.

### SUMMARY OF THE INVENTION

In one aspect, a method of laying out an input device comprising a plurality of input regions is provided, the method characterized by: (a) collecting coordinates for one or more contact points each corresponding to one or more reference inputs each associated with an input region; and (b) generating, using a layout unit, a layout of the input device based on one or more statistical characteristics of the contact points.

In another aspect, a system for laying out an input device comprising a plurality of input regions is provided, the system characterized by a layout unit operable to collect coordinates for one or more contact points each corresponding to one or more reference inputs each associated with an input region and to generate a layout of the input device based on one or more statistical characteristics of the contact points.

In a further aspect, a one line virtual keyboard is provided, the one line virtual keyboard characterized by a plurality of virtual keys comprising the grouping of letters {Q, A, Z}, {W, S, X}, {E, D, C}, {R, F, V}, {T, G, B}, {Y, H, N}, {U, J, M}, {I, K}, {O, L} and {P}.

### BRIEF DESCRIPTION OF THE DRAWINGS

The features of the invention will become more apparent in the following detailed description in which reference is made to the appended drawings wherein:

FIG. 1 is a system in accordance with the present invention;

FIG. 2 is a method in accordance with the present invention;

FIG. 3 is an example of a collection display;

FIG. 4 is a graphical representation of a set of collected contact points;

FIG. 5 is a chart showing efficacy of a disambiguation utility;

FIG. 6 is a time domain representation of a touchscreen tap and bezel tap;

FIG. 7 is a graphical representation of a user interacting with a gesture utility; and

FIG. 8 is a graphical representation of a one line keyboard.

### DESCRIPTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media.

It has been found that the layout of a typical soft keyboard does not consider the spatial distribution of typing on the QWERTY layout. It has been found that a user's fingers do not necessarily line up in a straight line when typing. Furthermore, different fingers have different spreads in target selection.

The present invention provides a system and method for input device layout. The input device comprises input regions. The input regions may, for example, be the various keys or buttons of the input device. In one aspect, the laid out input device is provided as a touchscreen (soft) input device. In another aspect, the laid out input device may be manufactured using a manufacturing process.

The present invention considers the spatial distribution of the contact points provided by one or more users' natural input. The present invention is operable to provide a layout for the input device that may, for example, be more ergonomic than a traditional version thereof by allocating the input regions accordingly. The present invention is operable to decrease the size of the input device relative to a traditional version thereof. One particular benefit of the resulting input device, in the case of a device that overlays a touchscreen input device on its output device, is that the screen space available for output may be increased relative to a traditional layout. An example of a reduced size input device is a one line keyboard.

In another aspect the input device may be a physical input device. The system and method is operable to provide an input device layout that is more user friendly than currently existing input devices. For example, the resulting input device may be more ergonomic than a traditional input device since input regions may be laid out to reflect natural contact points for a particular user or users.

In yet another aspect, an adaptive input device is provided. The adaptive input device may be a soft input device that has a layout adaptive to use and/or configuration by one or more users.

In a further aspect, a disambiguation utility is provided for disambiguating input provided on an input device. In a particular example, a disambiguation utility can be provided for enabling a reduced size input device to be utilized efficiently by a user.

In another aspect, an input device comprising a combination of a soft input device and physical inputs is provided. In another aspect, a soft keyboard comprising one or more soft input regions (keys) and one or more gesture based inputs is provided.

In further aspects, combinations of the foregoing may be provided.

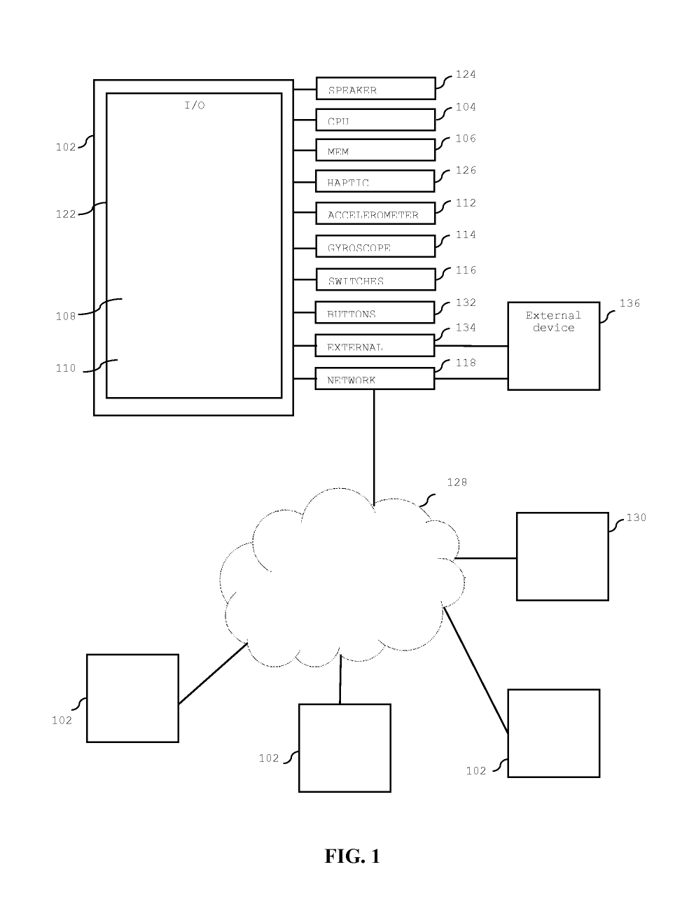

Referring now to FIG. 1, a computing device (102) is shown. The computing device (102) comprises or is linked to a processor (104), a memory (106), an output device (108) and an input device (110). The output device (108) may comprise a display (122) and may further comprise an audio output (124) and haptic output (126).

In particular embodiments, the input device (110) may comprise a touchscreen that is overlaid with the display (122). In other embodiments, the input device (110) may comprise capacitive touch sensors, physical contact sensors, touch sensors such as body conductance-based sensors, or applied machine vision sensors, motion capture sensors, audio triangulation sensors, or proximity sensors that are operable to determine user input location.

The input device (110) may further comprise additional input mechanisms including, for example, accelerometers (112), gyroscopes (114), switches (116) and buttons (132), which may be located in or on the computing device (102). The input device (110) may further comprise or be linked to an external device (136) linked to the computing device (102) by an external device link (134) which may be wired or wireless and/or by a network connection using a network adaptor (118). For example, the external device (136) may be linked to the network adaptor (118) by a Bluetooth™, WiFi (IEEE 802.1a/b/g/n), or other wireless networking protocol. The external device (136) may, for example, be a wireless keyboard or a mobile smartphone having a keyboard, touchscreen, or other input mechanisms.

The computing device (102) is operable to provide output to a user using the output device (108) and receive input from a user using the input device (110).

The memory (104) may, for example, comprise any one or more of a magnetic disk, RAM, ROM, Flash, EPROM, EEPROM, or other storage media. The memory (104) may have stored thereon computer instructions which, when executed by the processor, provide a layout unit (114) and other utilities and functionality as described herein.

In further embodiments, the layout unit (114) cooperates with layout units (114) of additional computing devices (102) that may be similarly configured as the computing device described above. In such cases, the computing device (102) may further comprise a network adaptor (118). The network adaptor (118) may link the computing device (102) to additional computing devices (102) by a network (128), such as the Internet. The additional computing devices (102) may provide a layout unit similar to the computing device described above. One or more of the linked layout units may provide the functionality described below by obtaining input from and providing output to one or more of the linked computing devices. In such an embodiment, one or more of the layout units may be operable to collect contact points from one or more computing devices and provide the functionality described below based on the collected contact points. A resulting laid out input device, as described below, can be provided on the specific computing device and/or other linked computing devices.

In still further embodiments, a server (130) may be linked to the network (128). The server may implement the layout unit (114) which is operable to obtain input from and provide output to each linked computing device (102). In such cases, each computing device (102) may or may not provide its own layout unit.

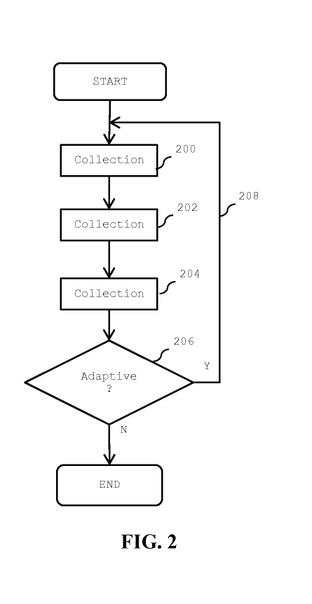

Referring now to FIG. 2, the layout unit implements a method of generating an input device layout. The method comprises the steps of collection (200) of input data and generation (202) of a layout. The generated layout may be output (204) to the display if the input device and display are overlaid. During the collection step, the layout unit obtains coordinates for contact points for the input device that a user associates with particular reference inputs. As previously mentioned, the layout unit may also collect data from other computing devices, or source devices. In particular examples, the collection step is provided for a plurality of users using one or more of the computing devices prior to executing the generation step. In the generation step, the input device is laid out based on the results of the collection step. In the output step, the laid out input device may be displayed on a touchscreen of one or more of the computing devices. Alternatively, the generated layout may be provided to a manufacturing process if the input device is a physical input device, such as keyboards or other machines. Such a manufacturing process can be any manufacturing process that results in the manufacture of an input device.

Furthermore, if the input device is a touchscreen input device or other dynamically configurable input device (206), the method may repeat (208) the steps of collection (200), generation (202) and output (204) at least once to adaptively update the layout of the input device.

In one example, during the collection step the layout unit instructs one or more users to provide at least one contact point for each of one or more particular reference inputs. The user may, for example, be requested to touch a touchscreen at a point that the user believes corresponds to a particular reference input. In a more specific example, the layout unit may instruct the user to touch the center point of the screen and the user may touch what he or she believes to be the center point. The touched point is the contact point while the actual center point of the touch screen is the reference input.

In another example, the user might be requested to envision a soft QWERTY keyboard (that may not be explicitly displayed) on a touchscreen. The layout unit may instruct the user to type one or more test phrase, comprising a plurality of characters, on the envisioned keyboard. The layout unit may collect the coordinates for each contact point corresponding to each of the characters of the test phrase, which are each reference inputs. Preferably, a plurality of test phrases, the aggregate of which comprises a plurality of instances of each reference input, is used. In this way, a plurality of contact points for each reference input can be collected by the layout unit.

For example, in the context of providing a layout for an input device that comprises a keyboard, the layout unit may provide instructions comprising one or more aurally or visually presented test phrases. The test phrases may comprise a plurality of characters corresponding to a plurality of keys of a keyboard. Preferably, the aggregate of the test phrases comprises every character in the language of the desired input device (for example, each letter of the English alphabet and punctuations for an English language keyboard) enabling the layout unit to obtain at least one contact point for each key of the desired input device.

The input device may be a touchscreen that is operable to provide the layout unit with coordinates for contact points corresponding to points that a user contacts in response to each test phrase. The input device may appear blank (or may comprise any other graphic) while the user is inputting each test phrase. The user may use his or her own recollection of a traditional desktop keyboard layout, for example, to input each test phrase. As each test phrase is typed on the touchscreen, the layout unit collects coordinates for the plurality of contact points corresponding to each character that is being input. It should be understood that the layout unit may provide feedback to the user using the output device, such as an audio feedback, in response to the user providing input. For example, the layout unit may output a “click” in response to an input using the output device.

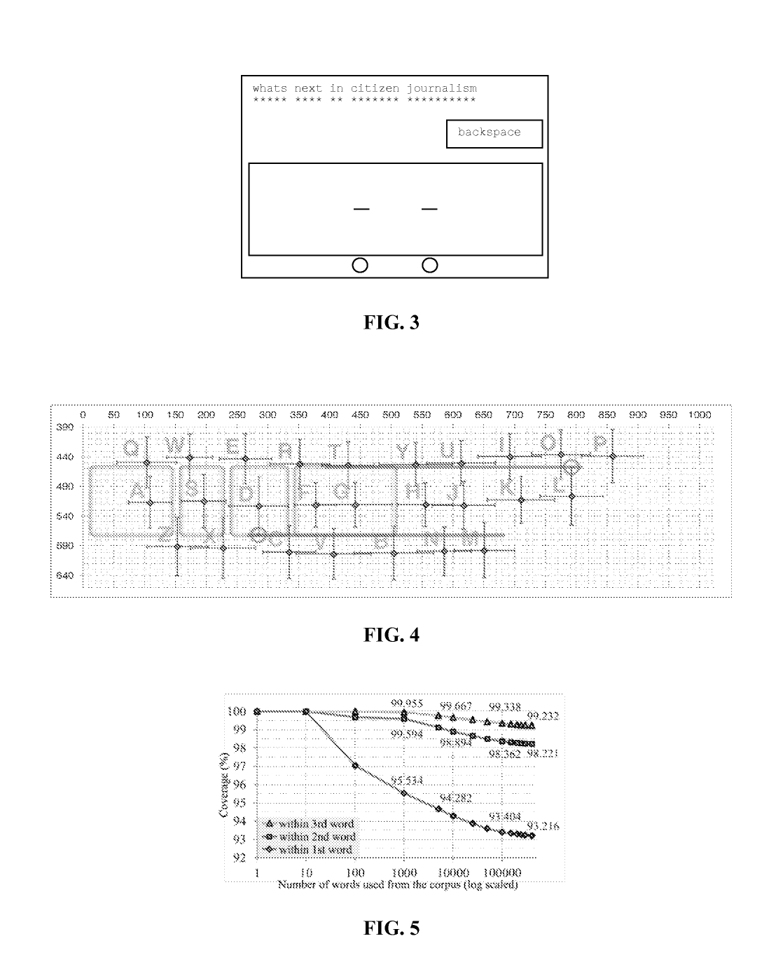

Referring now to FIG. 3, a touchscreen is shown. In a particular example of collecting coordinates, a user is required to type test phrases on a collection display. The collection display may comprise a portion of the touchscreen. The collection display may comprise a bounding box and one or more calibration point. The bounding box may, for example, be of about the same size as the factory default keyboard for the particular computing device used. In the particular example shown, the bounding box is about the same size as the three letter rows of the native keyboard for the particular computing device (an iPad in this example).

Preferably, one or more calibration points enable the user to home (re-position) their hands for the purposes of providing contact points during collection. For example, the one or more calibration points may comprise a portion of the touchscreen corresponding to at least one key that is provided outside the bounding box to prevent the user's hands from drifting during the collection step. In the particular example shown, the space bar key is condensed into two small buttons, one for each thumb. Thus, a user is required to touch one of these small buttons with the thumb in order to enter a space. Consequently, the user is forced to re-position their hands on the keyboard when a space is required to be entered. Preferably, the user is required to re-center both hands, for example by requiring the user to touch both space buttons to type a space.

The one or more calibration points may further comprise calibration points within the bounding box enabling the user to home their index fingers (or another digit). In the particular example shown, homing points are shown on the locations that correspond to the locations of the F and J keys of a QWERTY keyboard.

During the collection step, the output device optimally does not display keys, as displayed keys may psychologically influence the user when providing contact points.

Preferably, if the computing device supports “multi-touch” input, the multi-touch feature may be disabled during the collection step.

In one particular example of carrying out the collection step, a plurality of users was required to type a plurality of test phrases. Thirty of the test phrases were randomly selected from the MacKenzie & Soukoreff set (see MacKenzie, I. S., & Soukoreff, R. W. (2003). Phrase sets for evaluating text entry techniques. Extended Abstracts of the ACM Conference on Human Factors in Computing Systems—CHI 2003, pp. 754-755. New York: ACM, which is incorporated herein by reference). In order to mitigate the imbalance on the number of occurrences of letters such as j, y, and z, twenty special phrases were provided. These twenty phrases were created as follows. First, the most frequent words that use infrequent letters were located in the Corpus of Contemporary American English (COCA). Then meaningful phrases containing these words were identified. For example, one of the phrases “the grey zone of justice” contains three infrequent letters: j, y, and z. The final set of fifty phrases had, in aggregate, at least thirteen appearances of each letter and had a correlation with English of 0.9205 (calculated using AnalysePhrases™ (see MacKenzie, I. S., & Soukoreff, R. W. (2003). Phrase sets for evaluating text entry techniques. Extended Abstracts of the ACM Conference on Human Factors in Computing Systems—CHI 2003, pp. 754-755. New York: ACM, which is incorporated herein by reference); first fifty phrases from the MacKenzie & Soukoreff set had a correlation of 0.939).

Users may further be provided with practice phrases prior to the collection step. Additionally, to ensure a consistent starting hand position, users may be requested to press both the space buttons with their thumbs to activate a test phrase. As feedback, an asterisk may be displayed on the display for a non-space character and an underscore may be displayed on the display for a space character (as shown in FIG. 3). The contact points may be collected for every character that is not backspaced along with the reference inputs being the corresponding letters in the test phrase.

Thus, the layout unit obtains a plurality of contact points corresponding to a plurality of reference inputs.

Following collection, the layout unit executes the generation step. The generation step applies algorithms to lay out the input device based on the collected coordinates that represent each input of the input device.

During the generation step, the layout unit may select a subset of contact points for each reference input. For example, the aggregate of the test phrases may result in the collection of a plurality of different contact points for the reference input “A”. It may be desirable to discard a predetermined number of outliers, or outliers having one or more particular property or statistical characteristic, from the collected contact points.

Subsequently, the layout unit may determine one or more statistical characteristics of the contact points for one or more users. In a particular example, the mean may be determined of all contact points for a particular reference input for a particular user. Additionally, contact points that are recorded farther than three standard deviations from the mean, for example, may be removed as outliers. The remaining contact points for each reference input may be averaged across all users. In other examples, other statistical characteristics of the contact points can be used.

The generation step may consider the means and standard deviations, for example, of the contact points to determine the edges for the corresponding reference inputs on a laid out input device. For example, the keys of a laid out keyboard may be sized and located based on the means and standard deviations of the contact points for each key. Any multiple of standard deviation may be used.

Referring now to FIG. 4, to divide the horizontal space into different keys, the midpoint between the ends of adjacent error bars for the points of the home row keys A, S, D, and F may be used. These divisions provide a layout for the four left hand keys, the mirror of which may be used to layout the right hand keys. This symmetry keeps the layout consistent and clean. Calculations on the left handed letters (i.e., A, S, D, and F) instead of the right may be used because the most frequently used letters in the alphabet may be located on the left side of the QWERTY keyboard. Alternatively, the right hand keys can be laid out independently of the left hand keys and/or the left hand keys can be laid out based on mirroring the layout of the right-hand keys.

For example, to determine the widths of the keys in the home row of a QWERTY keyboard, the layout unit may execute the following steps:
1. Calculate the means and standard deviations of each of the letters in the x-axis.
2. Add 2 standard deviations (SD) to the mean of the contact points for the reference input “A” in the x-axis (where “add” indicates movement to the right along the x-axis). Subtract 2SD from the mean of the contact points for the reference input “S” in the x-axis (where “subtract” indicates movement to the left along the x-axis). Find the midpoint between these two values. This midpoint may be used as the right edge of the “A” key on home row of the laid out input device. Alternatively, if padding between adjacent keys is desired, the right edge of the “A” key may be adjusted to the left by a predetermined amount (the padding amount or a portion thereof). The left edge of the “A” key may be the left edge of the screen, or a predetermined distance (padding) from the left edge of the screen.
3. Add 2SD to the mean of the contact points for the reference input “S” in the x-axis. Subtract 2SD from the mean of the contact points for the reference input “D” in the x-axis. Find the midpoint between these two values. This midpoint is the right edge of the “S” key. The left edge of the “S” key is the right edge of the “A” key, or a predetermined distance (padding) between the two keys may be provided.
4. Add 2SD to the mean of “D” in the x-axis. Subtract 2SD from the mean of “F” input in the x-axis. Find the midpoint between these two values. This midpoint is the right edge of the “D” key. The left edge of the “D” key is the right edge of the “S” key, or a predetermined distance (padding) between the two keys may be provided.
5. The right edge of the “F” key is the middle of the screen. The left edge of the “F” key is the right edge of the “D” key, or a predetermined distance (padding) between the two keys may be provided.
6. Mirror the left hand keys to the right using the center axis. The mirrored keys will be the right hand keys.
7. Alternatively to step 6, a similar process to steps 1-5 can be used for independently laying out the right hand keys.
8. Alternatively to steps 1 to 6, the right hand keys could be laid out first, and then mirrored to the left hand keys.
9. Alternatively to steps 1 to 6, all keys could be independently laid out.

The layout unit may determine the distance between the highest and lowest error bars of the home row to determine the height of the keys. In this case, the layout unit may execute the following steps to generate the vertical spacing of the keyboard:
1. Calculate the means and standard deviations of each of the home row keys in the y-axis.
2. Subtract 2 SD from the respective means in y-axis, record the minimum of the nine differences.
3. Add 2SD to the respective means in the y-axis, record the maximum of the nine sums.
4. The height of all the keys may be the distance between the minimum and the maximum.
5. Alternatively, the height of each key could be independently calculated to be twice the 2SD of the respective key.

A similar process can be used for the remaining rows of the keyboard to be laid out.

In the above example, the width and height of each key are based on the error bars of 2SD. Two standard deviations may provide the least amount of overlap with neighbouring error bars (as shown in FIG. 4) in certain implementations, however in other implementations 2SD may not result in the least amount of overlap. In those cases, other implementations should use a multiple, or other scaling factor, other than 2.

Furthermore, instead of using the means and standard deviations of the contact points as described above, the layout may use any other statistical characteristics of the contact points, such as the medians, quartiles and/or percentiles, for example. The centers, widths, and/or heights of the keys can be computed from the medians and a certain percentile of all the data collected.

It will be appreciated that the foregoing process may result in an input device comprising non-uniformly sized input regions.

The resulting laid out keyboard can be displayed on the output device or provided to a manufacturing process, as previously described.

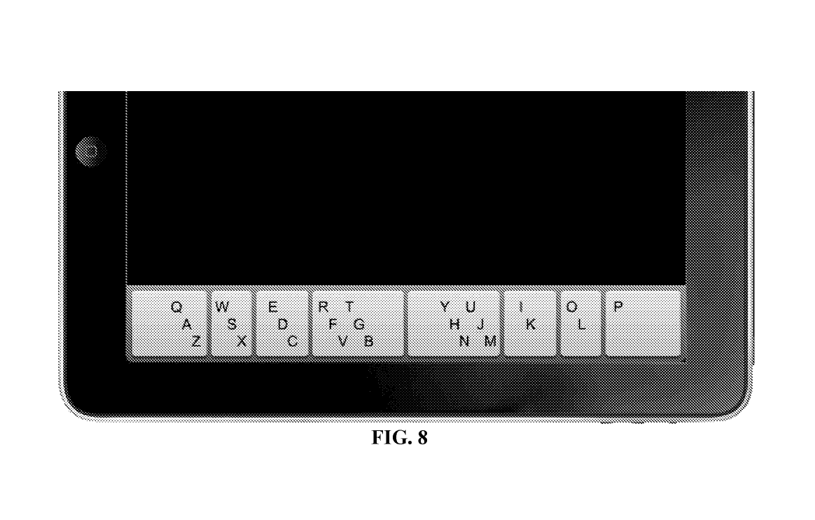

In a further aspect of the present invention, a one line soft keyboard is provided. The one line soft keyboard (hereinafter referred to as a “1Line keyboard”) may be presented as a QWERTY keyboard. An example of a 1Line keyboard is about 140 pixels tall (in landscape mode of a tablet) and about 40% of the height of a native QWERTY keyboard of the tablet. The 1Line keyboard may, for example, condense a plurality of rows of keys from a typical QWERTY layout into a single row with a plurality of keys. For example, the three letter rows of a typical QWERTY keyboard may be condensed into a single row of eight keys. Referring now to FIG. 8, in a particular example of a one line keyboard, the following groups of characters can each be represented by a single key: {Q, A, Z}, {W, S, X}, {E, D, C}, {R, F, V, T, G, B}, {Y, H, N, U, J, M}, {I, K}, {O, L} and {P}. An alternative grouping of keys comprises {Q, A, Z}, {W, S, X}, {E, D, C}, {R, F, V}, {T, G, B}, {Y, H, N}, {U, J, M}, {I, K}, {O, L} and {P}.

The memory may additionally comprise computer instructions which, when executed by the processor, provide an input interface. The input interface may comprise a display utility to display an input interface, a disambiguation utility to provide word disambiguation, a gesture utility to enable gesture-based input and a physical input utility to enable user input by additional input mechanisms.

The display utility may be operable to output the input interface corresponding to the laid out input device generated by the layout unit.

The disambiguation utility may disambiguate words a user types on the 1Line keyboard. Disambiguation may be based on the sequence of keys pressed and using word frequencies calculated from a particular language corpus, for example. If the user's desired word is not the first disambiguated word, she can perform gestures to navigate through a list of possible words to select the intended text. The user may select the intended text by touching it on the input device.

Since each of the eight keys may be associated with multiple letters (e.g., the leftmost key can type the letters Q, A, or Z), word disambiguation may be used to reduce the number of inputs required in a keyboard to type a particular word.

In one aspect of the present invention, disambiguation may be provided by generating a modified Corpus of Contemporary American English (COCA). In the modified COCA of the present invention, all entries containing non-alphabetic characters may be disregarded. A hash table of all remaining words may be provided using the finger sequence as the key and the word as the value. For example, the word “test” may be assigned to a finger sequence of left-index, left-middle, left-ring, and left-index. All the words that have the same finger sequence may be sorted by their frequency in the COCA. Thus, the present disambiguation algorithm suggests the most frequently-used word first depending on the sequence of the key pressed.

Referring to FIG. 5, the coverage of the alphabet-only words in COCA using the disambiguation algorithm is provided. To calculate coverage, the percentage of words that appear as the most likely word for its key sequence and the percentage of words that appear in the top two and three most likely words for its key sequence are determined (any number of words could be used). These results show that in the top 10,000 words, 94.28% can be typed without the need for disambiguation and 99.667% appear in the top three most likely words for any key sequence.

The disambiguation utility may also provide adaptive word ranking. For example, if the user types a lower frequency word (according to COCA) repeatedly, the disambiguation utility could give that word higher priority in the disambiguation. The disambiguation utility may also learn words that a user enters that were not previously listed in the COCA.

The disambiguation utility may provide a predetermined number of the most likely words on the display and enable the user to select one of these words as the word being typed.

Referring now to FIG. 7, in another aspect, the gesture utility enables additional inputs by the user. For example, the gesture utility may enable the user to perform certain commands by providing one of at least one gesture on the area corresponding to the laid out input device, including for example backspace and enter.

Examples of gestures implementable by the gesture utility comprise:
One-finger left flick: Backspace (hold to repeat)
One-finger right flick: Enter
One-finger down flick: Navigates to the next word suggested by our word disambiguation algorithm (hold to repeat)
One-finger up flick: Navigates to the previous word suggested by our word disambiguation algorithm (hold to repeat)
Two-finger left flick: Deletes the whole word

Additional gestures may comprise any multi-finger flicks. There may be four flick directions (up, down, left, right) and ten fingers. Additional flick directions could include diagonals or patterns comprising more than one direction. Commands may be associated to a flick in any flick directions with any number of fingers. These operations can be, for example, caps-lock, num-lock, home, end, insert, page down, page up, function keys, tab, etc.

For example, the user could toggle the caps-lock by flicking up or down with two fingers. The user also could switch to a numeric or symbolic layout of a keyboard with 3-finger flicks upward or downward.

In another aspect, the physical input utility may enable the user to provide input commands using physical inputs. For example, the user may activate accelerometers (such as MEMS accelerometers) and/or gyroscopes and/or switches to provide commands. One example comprises a user tapping on the bezel below the keyboard to input a space by causing an accelerometer to respond in a predetermined manner.

The physical input utility may implement sampling to detect physical input. For example, the physical input utility may sample the accelerometer at 100 Hz and compute the second order finite difference (fd[n]) using the values in the Z-axis (the axis perpendicular to the device screen). Each accelerometer measurement may provide a system time (t[n]) and the acceleration along the z axis (z[n]). The formula for fd[n] may be provided as:

$${fd}_{[ n ]} = \frac{{z}_{[ n - 2 ]} - 2 {z}_{[ n - 1 ]} + {z}_{n}}{( {t}_{[ n - 1 ]} - {t}_{[ n - 2 ]} ) ( {t}_{[ n ]} - {t}_{[ n - 1 ]} )} \qquad ( 1 )$$

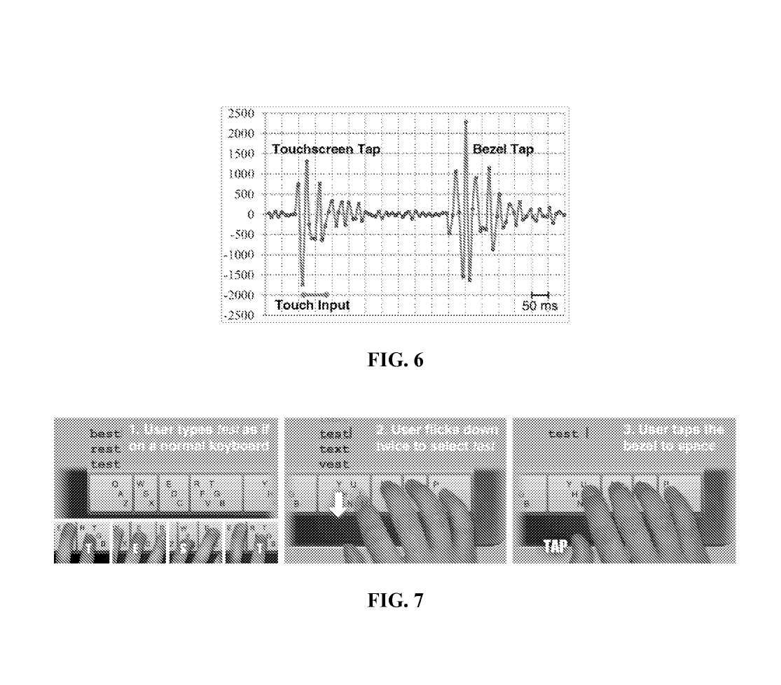

Referring now to FIG. 6, an example of fd[n] is shown over the course of two example taps. A window of ten previous difference values (equivalent to 100 ms) is monitored for a significant positive and negative deviation from zero in the finite difference. Empirical evidence suggests 800 m/s⁴ as an acceptable threshold. The physical input utility may also monitor all touch events on the screen. When an acceleration spike which exceeds the threshold occurs and a touch-down event does not happen concurrently, the physical input utility may consider the spike as a tap on the bezel. When the difference becomes greater than 10,000 m/s⁴, for example, the physical input utility may ignore the acceleration data. This can happen when, for instance, the user moves the device. The physical input utility may ignore acceleration data while the user is touching the screen and again for the first five samples after detecting any tap to avoid false detection of multiple taps.

In addition, taps that are not along the central plane of the device may register a change in the acceleration along the X and, to a lesser extent, the Y-axis. Movement in the X-axis can be used to distinguish left, right and center bezel taps, which enables a richer keyboard experience without the expense of extra screen real estate or smaller keys. For example, users could tap the center of the device to enter a space, but tap its left side to toggle caps-lock and the right side to toggle num-lock.

In one evaluation, the 1Line keyboard enabled users to quickly learn how to type at a rate of over 30 WPM after just five 20-minute typing sessions. Using a keystroke level model, it is predicted that the peak expert text entry rate with the 1Line keyboard may be 66-68 WPM.

In the above description, the design of the keys is the same for all users. In another aspect, the layout of the input device may be responsive to or configurable based on user demographics. Female hands are, on average, smaller than male hands, likewise with child hands verses adult hands.

The layout unit may be operable to obtain demographic information from a user prior to the collection step and/or prior to generation. For example, the layout unit may provide a prompt requesting the user to confirm particular demographic information. In another example, during collection the layout unit may compare collected contact points with contact point samples from other users that provided demographic information and, correspondingly, associate such demographic information to the current user.

The layout unit may be operable to customize an input device layout for each category of users (female children, female teens, female adults, female older adults, female elders, etc.). Moreover, the typing behaviour of English by North Americans might be different than Indians or any other culture. The layout unit may further be operable to customize an input device layout for different geographic regions.

Additionally, the size of the keys need not be fixed and can adapt to user behaviour. For example, there may be two options for adaptive sizing. In the first option, sizes can change based on the word being entered. For example, if a user types “th”, the next letter is most likely “e” (e.g., the) or “i” (e.g., this). Thus, the keys for “e” or “i” could grow larger after “th” is typed. In the second option, the keyboard can adapt to the user's typing over time. The keyboard records the contact points of where the user has entered a correct letter. Then the sizes of the keys may be continuously or at certain time intervals updated using the automation process described before.

In addition, an external device can be linked to the computing device to provide an extension to the keyboard or other input device. For example, by docking a smart phone below a tablet running the 1Line Keyboard, a user could use the phone as an extension to the keyboard. The phone can act as a spacebar, a keypad, and/or other modifier keys. The phone may be connected to the tablet using Bluetooth, Wifi, or any other wireless or wire technologies.

The above description discusses a specific example embodiment of a QWERTY keyboard. However, several other applications are now provided.

The present invention reduces the space needed for an input device. In some highly specialized settings, the present invention can be used to save space without affecting performance. For example in airport kiosks or manufacturing plant controls, only a few keys may exist or be regularly used. With an optimized dictionary and/or disambiguation algorithm, the present invention can be used to save space without sacrificing performance. The layout unit can similarly be used to determine an optimal ergonomic layout of single-button devices, such as those on an assembly line, using contact point samples provided by assembly line workers.

Reducing the keyboard can also reduce the cost and weight of a design. For example, some devices have a physical QWERTY keyboard. By using the herein described system and method for generating an input device layout, the cost of building and the weight of the design can be lowered (less keys and parts).

Additionally, some physical QWERTY keyboards on mobile devices are very small and hard to type on. A hard cover with fewer keys can go over a QWERTY keyboard to convert it into a 1Line keyboard or other reduced layouts.

Furthermore, the present invention can be extended beyond physical and touchscreen input devices. For example, the present invention can be applied to a Theremin-like interface that separates a region in mid-air into eight or more regions. Users may trigger the different regions as if playing a Theremin. A blow interface can also be used. Research has shown that by using a single microphone, a system can distinguish users blowing at up to 16 regions. The present invention may be applied to these regions to support typing. These two typing interfaces (mid-air waving and blowing) do not require any physical contact to the keyboard. This can be especially useful in situations where sanitation is important (e.g., hospital operating rooms).

A wearable keyboard based on the 1Line concept is also provided. The 1Line keyboard can be operated using 10 or fewer input points, and thus can be mapped to finger movements. A device may be worn on the human body that detects which finger is moved (for example wrist bracelets or rings). Using the wearable keyboard, the user can type on any surfaces and in any environments.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A method of laying out an input device comprising a plurality of input regions, the method characterized by:
(a) collecting coordinates for one or more contact points each corresponding to one or more reference inputs each associated with an input region; and
(b) generating, using a layout unit, a layout of the input device based on one or more statistical characteristics of the contact points.

2. The method of claim 1, characterized in the coordinates are collected from one or more users interacting with the input device.

3. The method of claim 1, characterized in that the one or more statistical characteristics relate to spatial distribution of the coordinates.

4. The method of claim 1, characterized in that the coordinates are collected from a plurality of source devices.

5. The method of claim 1, characterized in that the layout unit generates the input device by allocating a plurality of reference inputs to at least one of the input regions.

6. The method of claim 1, characterized in that the statistical characteristics comprise at least one of mean, a multiple of a standard deviation, median, percentile and quartile of the coordinates corresponding to each reference input.

7. The method of claim 1, characterized in that the layout unit generates the layout by spatially distributing the input regions based on the statistical characteristics.

8. The method of claim 7, characterized in that the layout unit separates adjacent input regions by a predetermined padding amount.

9. The method of claim 2, characterized in that the layout unit repeats the collecting and generating at least once to provide an adaptive input device.

10. The method of claim 1, characterized in that the input device is a touchscreen input device overlaid upon a display.

11. A system for laying out an input device comprising a plurality of input regions, the system characterized by a layout unit operable to collect coordinates for one or more contact points each corresponding to one or more reference inputs each associated with an input region and to generate a layout of the input device based on one or more statistical characteristics of the contact points.

12. The system of claim 1, characterized in the coordinates are collected from one or more users interacting with the input device.

13. The system of claim 1, characterized in that the one or more statistical characteristics relate to spatial distribution of the coordinates.

14. The system of claim 1, characterized in that the coordinates are collected from a plurality of source devices.

15. The system of claim 1, characterized in that the layout unit is operable generate the input device by allocating a plurality of reference inputs to at least one of the input regions.

16. The system of claim 1, characterized in that the statistical characteristics comprise at least one of mean, a multiple of a standard deviation, median, percentile and quartile of the coordinates corresponding to each reference input.

17. The system of claim 1, characterized in that the layout unit is operable to generate the layout by spatially distributing the input regions based on the statistical characteristics.

18. The system of claim 7, characterized in that the layout unit is operable to separate adjacent input regions by a predetermined padding amount.

19. The system of claim 2, characterized in that the layout unit is operable to repeat the collecting and generating at least once to provide an adaptive input device.

20. The system of claim 1, characterized in that the input device is a touchscreen input device overlaid upon a display.

21. A one line virtual keyboard characterized by a plurality of virtual keys comprising the grouping of letters {Q, A, Z}, {W, S, X}, {E, D, C}, {R, F, V}, {T, G, B}, {Y, H, N}, {U, J, M}, {I, K}, {O, L} and {P}.
